(19) United States
(12) Patent Application Publication
(10) Pub. No.: US 2026/0253804 A1
(43) Pub. Date: Aug. 27, 2026

(54) MULTILAYER ELECTRONIC COMPONENT

(71) Applicant: SAMSUNG ELECTRO-MECHANICS CO., LTD., Suwon-si (KR)

(72) Inventors: Ah Young LEE, Suwon-si (KR); Ju Yeon CHO, Suwon-si (KR); Ji Yun AN, Suwon-si (KR); Gi Sub LEE, Suwon-si (KR)

(73) Assignee: SAMSUNG ELECTRO-MECHANICS CO., LTD., Suwon-si (KR)

(21) Appl. No.: 19/437,639

(22) Filed: Dec. 31, 2025

(30) Foreign Application Priority Data
Feb. 27, 2025 (KR) 10-2025-0025627

(51) Int. Cl. H01G 4/30; H01G 4/232

(52) U.S. Cl. CPC H01G 4/30; H01G 4/232

(57) ABSTRACT

A multilayer electronic component includes a dielectric layer and internal electrodes alternately disposed with the dielectric layer in a thickness direction; a body including first and second surfaces opposing each other in the thickness direction, and third and fourth surfaces connected to the first and second surfaces and opposing each other in a length direction; a first external electrode disposed on the third surface; and a second external electrode disposed on the fourth surface, wherein a central external electrode spaced apart from the first external electrode, the second external electrode, and the internal electrode is disposed on one or more of the first and second surfaces of the body, and wherein, when a length of the multilayer electronic component is defined as L and a length of the central external electrode is defined as CL, CL/L is 0.10 or more and 0.35 or less.

### CROSS-REFERENCE TO RELATED APPLICATION(S)

The application claims benefit of priority to Korean Patent Application No. 10-2025-0025627 filed on Feb. 27, 2025 in the Korean Intellectual Property Office, the disclosure of which is incorporated herein by reference in its entirety.

### BACKGROUND

### 1. Field

The present disclosure relates to a multilayer electronic component.

### 2. Description of Related Art

A multilayer ceramic component (MLCC), a multilayer electronic component, may be a chip condenser mounted on the printed circuit boards of various electronic products including image display devices such as a liquid crystal display (LCD) and a plasma display panel (PDP), a computer, a smartphone, a mobile phone, or the like, and charging or discharging electricity therein or therefrom.

A multilayer ceramic capacitor may be used as a component of various electronic devices, as a multilayer ceramic capacitor may have a small size and high capacitance and may be easily mounted. As various electronic devices such as a computer and a mobile device have been designed to have a reduced size and higher output, demand for miniaturization and/or higher capacitance for a multilayer ceramic capacitor has increased.

A high-voltage MLCC may have significantly higher rated voltages than a standard MLCC, such that reliability may be evaluated based on higher voltage.

In the case of a high-voltage MLCC, the potential difference between the external electrodes, caused by high voltage application and use in humid environments, may cause arc discharges which temporarily cause insulation breakdown through the gas. The arc discharges may reduce MLCC reliability.

To ensure reliability at high voltage, there have been attempts to increase a thickness of a dielectric layer and to modify a pattern design of an internal electrode. However, relatively few attempts have been made to ensure reliability at high voltage by modifying the design of external electrodes.

Thus, it has been necessary to develop a multilayer electronic component which may ensure reliability at high voltage by modifying the design of external electrodes.

### SUMMARY

An embodiment of the present disclosure is to provide a multilayer electronic component having improved reliability.

An embodiment of the present disclosure is to provide a multilayer electronic component which may suppress arc discharge.

An embodiment of the present disclosure is to provide a multilayer electronic component which may suppress cracks caused by electrostriction.

According to an embodiment of the present disclosure, a multilayer electronic component includes a dielectric layer and internal electrodes alternately disposed with the dielectric layer in a thickness direction; a body including first and second surfaces opposing each other in the thickness direction, third and fourth surfaces connected to the first and second surfaces and opposing each other in a length direction, and fifth and sixth surfaces connected to the first to fourth surfaces and opposing each other in a width direction; a first external electrode disposed on the third surface; a second external electrode disposed on the fourth surface; and a central external electrode spaced apart from the first external electrode, the second external electrode, and the internal electrodes, wherein the central external electrode is disposed on one or more of the first and second surfaces of the body, wherein, when a length of the multilayer electronic component is defined as L and a length of the central external electrode is defined as CL, CL/L is 0.10 or more and 0.35 or less.

### BRIEF DESCRIPTION OF DRAWINGS

The above and other aspects, features, and advantages of the present disclosure will be more clearly understood from the following detailed description, taken in combination with the accompanying drawings, in which:

FIG. 1 is a perspective diagram illustrating a multilayer electronic component according to an embodiment of the present disclosure;

FIG. 2 is a cross-sectional diagram taken along line I-I′ in FIG. 1;

FIG. 3 is a cross-sectional diagram taken along line II-II′ in FIG. 1;

FIG. 4 is an exploded diagram illustrating a body according to an embodiment of the present disclosure;

FIG. 5 is a perspective diagram illustrating a multilayer electronic component according to a modified example of the present disclosure;

FIG. 6 is a cross-sectional diagram taken along line III-III′ in FIG. 5;

FIG. 7 is a cross-sectional diagram illustrating a substrate mounted on the multilayer electronic component illustrated in FIG. 1;

FIG. 8 is a diagram illustrating the effect of suppressing volume expansion due to electrostriction according to an example; and

FIG. 9 is a diagram illustrating the effect of suppressing volume expansion due to electrostriction according to a comparative example.

### DETAILED DESCRIPTION

Hereinafter, embodiments of the present disclosure will be described as below with reference to the accompanying drawings.

The embodiments of the present disclosure may be modified in various different forms, and the scope of the present disclosure is not limited to the embodiments described below. Also, the embodiments of the present disclosure are provided to more fully describe the present disclosure to those skilled in the art. Accordingly, the shapes and sizes of elements in the drawings may be exaggerated for clarity, and elements indicated by the same reference numerals in the drawings are identical elements.

In the drawings, to clearly describe the present disclosure in the drawings, irrelevant parts may be omitted, and the size and thickness of each component in the drawings have been arbitrarily indicated for ease of description, and thus, the present disclosure is not necessarily limited thereto. Also, the terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof.

In the drawings, the X direction may be defined as the first direction, the lamination direction or the thickness T direction, the Y direction may be defined as the second direction or the length L direction, and the Z direction may be defined as the third direction or the width W direction.

As disclosed herein, CL, L, GL, CT, and BT may be measured by an optical microscope and/or a scanning electron microscope (SEM). Other methods and/or tools appreciated by one of ordinary skill in the art, even if not described in the present disclosure, may also be used.

### Multilayer Electronic Component

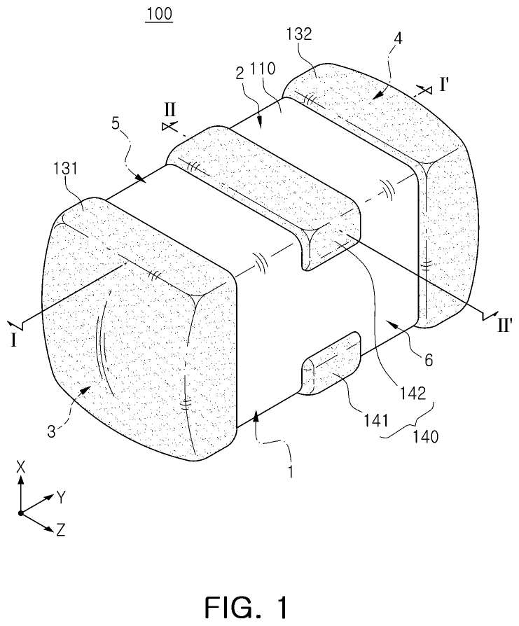

FIG. 1 is a perspective diagram illustrating a multilayer electronic component according to an embodiment.

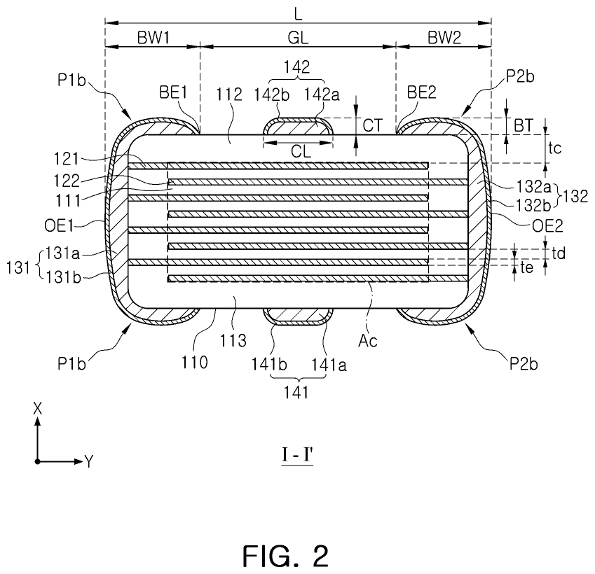

FIG. 2 is a cross-sectional diagram taken along line I-I′ in FIG. 1.

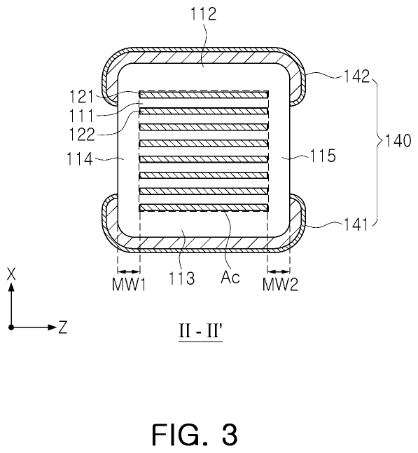

FIG. 3 is a cross-sectional diagram taken along line II-II′ in FIG. 1.

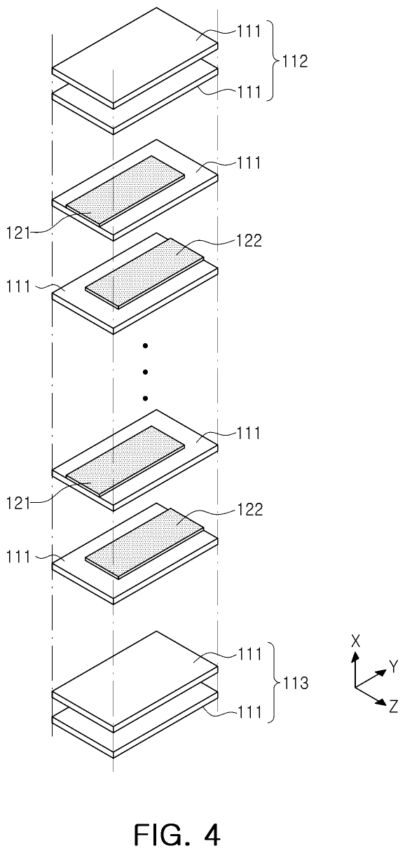

FIG. 4 is an exploded diagram illustrating a body according to an embodiment.

Hereinafter, a multilayer electronic component 100 according to an embodiment of the present disclosure will be described in detail with reference to FIGS. 1 to 4. Also, a multilayer ceramic capacitor (hereinafter referred to as “MLCC”) is described as an example of the multilayer electronic component, but an embodiment thereof is not limited thereto, and may be applied to various multilayer electronic components using a ceramic material, such as an inductor, piezoelectric element, varistor, or thermistor.

A multilayer electronic component according to an embodiment of the present disclosure may include a dielectric layer 111 and internal electrodes 121 and 122 alternately disposed with the dielectric layer in a thickness direction; a body including first and second surfaces 1 and 2 opposing each other in the thickness direction, third and fourth surfaces 3 and 4 connected to the first and second surfaces and opposing each other in the length direction, and fifth and sixth surfaces 5 and 6 connected to the first to fourth surfaces and opposing each other in the width direction; a first external electrode 131 disposed on the third surface; and a second external electrode 132 disposed on the fourth surface, wherein a central external electrode 140 spaced apart from the first external electrode, the second external electrode, and the internal electrode is disposed on one or more of the first and second surfaces of the body, and wherein, when a length of the multilayer electronic component is defined as L and a length of the central external electrode is defined as CL, CL/L is 0.10 or more and 0.35 or less.

In the description below, each of the components included in the multilayer electronic component 100 according to an embodiment of the present disclosure will be described.

In the body 110, the dielectric layers 111 and the internal electrodes 121 and 122 may be alternately laminated.

The shape of the body 110 may not be limited to any particular shape, but as illustrated, the body 110 may have a hexahedral shape or a shape similar to a hexahedral shape. Due to reduction of ceramic powder included in the body 110 during a firing process or polishing of corners, the body 110 may not have an exactly hexahedral shape formed by linear lines but may have a substantially hexahedral shape.

The body 110 may have first and second surfaces 1 and 2 opposing each other in the first direction, third and fourth surfaces 3 and 4 connected to the first and second surfaces 1 and 2 and opposing in the second direction, and fifth and sixth surfaces 5 and 6 connected to the first and second surfaces 1 and 2 and the third and fourth surfaces 3 and 4 and opposing each other in the third direction.

As the margin region in which the internal electrodes 121 and 122 are not disposed overlaps on the dielectric layer 111, a difference in the thicknesses of the internal electrodes 121 and 122 may occur, such that the corner connecting the first surface and the third to fifth surfaces and/or the corner connecting the second surface and the third to fifth surfaces may have a shape reduced toward the center in the first direction of the body 110 when viewed from the first surface or the second surface. Alternatively, due to the reduction behavior during the process of sintering the body, the corner connecting the first surface 1 and the third to sixth surfaces 3, 4, 5, and 6 and/or the corner connecting the second surface 2 and the third to sixth surfaces 3, 4, 5, and 6 may have a shape reduced toward the center in the first direction of the body 110 when viewed from the first surface or the second surface. Alternatively, to prevent chipping defects, the corners connecting each surface of the body 110 may have a rounded shape by performing a separate process, such that each of the corners connecting the first surface and the third to sixth surfaces and/or the corners connecting the second surface and the third to sixth surfaces may have a rounded shape.

To suppress the difference caused by the internal electrodes 121 and 122, when the internal electrodes are cut such that the internal electrodes are exposed to the fifth and sixth surfaces 5 and 6 of the body after lamination, and margin portions 114 and 115 are formed by laminating a dielectric layer or two or more dielectric layers in the third direction (width direction) on both side surfaces of the capacitance formation portion Ac, the portion connecting the first surface and the fifth and sixth surfaces and the portion connecting the second surface and the fifth and sixth surfaces may not have a reduced shape.

The plurality of dielectric layers 111 forming the body 110 may be in a fired state, and boundaries between adjacent dielectric layers 111 may be integrated with each other such that boundaries therebetween may not be distinct without using a scanning electron microscope (SEM). It may not be necessary to specifically limit the number of laminates of the dielectric layer, and the number of laminates may be determined by considering the size of the multilayer electronic component. For example, the body may be formed by laminating 400 or more layers of the dielectric layer.

The dielectric layer 111 may be formed by preparing a ceramic slurry including ceramic powder, an organic solvent, and a binder, applying and drying the slurry on a carrier film to prepare a ceramic green sheet, and sintering the ceramic green sheet. The ceramic powder is not particularly limited as long as sufficient electrostatic capacitance may be obtained, but for example, a barium titanate-based (BaTiO₃) powder may be used as the ceramic powder. For more specific examples, as for the ceramic powder, a barium titanate-based (BaTiO₃) powder, a CaZrO₃-based paraelectric powder, or the like, may be used. For a more specific example, the barium titanate (BaTiO₃) powder may be one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) and Ba(Ti_{1-y}Zr_{y})O₃ (0<y<1), and the CaZrO₃-based paraelectric powder may be (Ca₁₋ₓSrₓ)(Zr_{1-y}Ti_{y})O₃ (0<x<1, 0<y<1).

Accordingly, the dielectric layer 111 may include one or more of BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1), Ba(Ti_{1-y}Zr_{y})O₃ (0<y<1), (Ca₁₋ₓSrₓ)(Zr_{1-y}Ti_{y}) O₃ (0<x<1, 0<y<1). In an embodiment, the dielectric layer 111 may include (Ca₁₋ₓSrₓ)(Zr_{1-y}Ti_{y})O₃ (0<x<1, 0<y<1) as a main component.

The body 110 may include a capacitance formation portion Ac forming capacitance including the first internal electrode 121 and the second internal electrode 122 disposed in the body 110 and opposing each other with the dielectric layer 111 therebetween, and cover portions 112 and 113 formed in upper and lower portions in the first direction of the capacitance formation portion Ac.

Also, the capacitance formation portion Ac may contribute to forming the capacitance of the capacitor, and may be formed by repeatedly laminating the plurality of first and second internal electrodes 121 and 122 with the dielectric layer 111 interposed therebetween.

The cover portions 112 and 113 may include an upper cover portion 112 disposed on an upper portion in the first direction of the capacitance formation portion Ac and a lower cover portion 113 disposed on a lower portion in the first direction of the capacitance formation portion Ac.

The upper cover portions 112 and the lower cover portions 113 may be formed by laminating a single dielectric layer or two or more dielectric layers on the upper and lower surfaces of the capacitance formation portion Ac in the thickness direction, respectively, and may prevent damages to the internal electrode due to physical or chemical stress.

The upper cover portions 112 and the lower cover portions 113 may not include an internal electrode and may include the same material as that of the dielectric layer 111.

That is, the upper cover portions 112 and the lower cover portions 113 may include a ceramic material, for example, a barium titanate (BaTiO₃) ceramic material.

The thickness of the cover portions 112 and 113 may not be limited to any particular example. For example, to implement miniaturization and high capacitance of the multilayer electronic component, a thickness tc of the cover portions 112 and 113 may be 100 μm or less.

The average thickness tc of the cover portions 112 and 113 may indicate the size in the first direction, and may be an average value of the sizes in the first direction of the cover portions 112 and 113 measured at five points at an equal distance in the upper portion or the lower portion of the capacitance formation portion Ac.

Also, the margin portions 114 and 115 may be disposed on side surfaces of the capacitance formation portion Ac.

The margin portions 114 and 115 may include a first margin portion 114 disposed on the fifth surface 5 of the body 110 and a second margin portion 115 disposed on the sixth surface 6. That is, the margin portions 114 and 115 may be disposed on both end surfaces of the body 110 in the width direction.

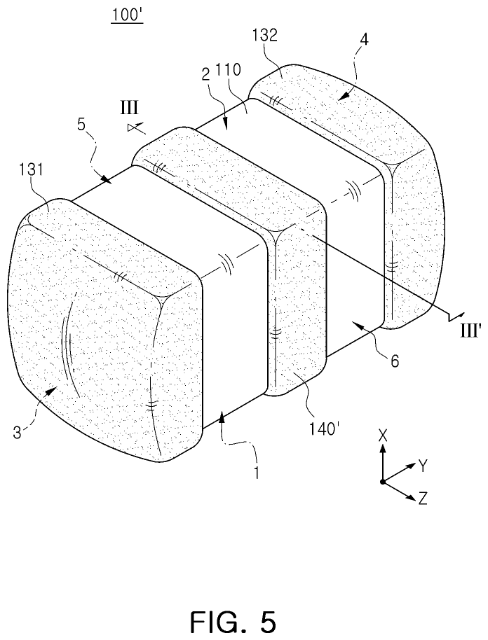

The margin portions 114 and 115 may indicate a region between both ends of the first and second internal electrodes 121 and 122 and the boundary surface of the body 110 in a cross-section in the width-thickness (W-T) direction of the body 110 as illustrated in FIG. 5.

The margin portions 114 and 115 may basically prevent damages to the internal electrode due to physical or chemical stress.

The margin portions 114 and 115 may be formed by forming an internal electrode by applying a conductive paste on the ceramic green sheet other than the region in which the margin portion is to be formed.

Also, to prevent a step difference caused by the internal electrodes 121 and 122, after laminating, the margin portion 114 and 115 may be formed by cutting the internal electrode to be exposed to the fifth and sixth surfaces 5 and 6 of the body, and laminating a single dielectric layer or two or more dielectric layers on both side surfaces of the capacitance formation portion Ac in the third direction (width direction).

Widths of the margin portions 114 and 115 may not be limited to any particular example. To implement miniaturization and high capacitance of the multilayer electronic component, the average width of the margin portions 114 and 115 may be 15 μm or less.

The average width of margin portions 114 and 115 may refer to the average size MW1 in the third direction of the region in which the internal electrode is spaced apart from the fifth surface and the average size MW2 in the third direction of the region in which the internal electrode is spaced apart from the sixth surface, and may be the average value of the sizes in the third direction of the margin portions 114 and 115 measured at five points at an equal distance on the side surface of the capacitance formation portion Ac.

Accordingly, in an embodiment, each of the average sizes MW1 and MW2 in the third direction of the region spaced apart from the fifth and sixth surfaces of the internal electrodes 121 and 122 may be 15 μm or less.

The internal electrodes 121 and 122 may include first and second internal electrodes 121 and 122. The first and second internal electrodes 121 and 122 may be alternately disposed to oppose each other with the dielectric layer 111 included in the body 110 therebetween, and may be exposed to the third and fourth surfaces 3 and 4 of the body 110, respectively.

The first internal electrode 121 may be spaced apart from the fourth surface 4 and may be exposed through the third surface 3, and the second internal electrode 122 may be spaced apart from the third surface 3 and may be exposed through the fourth surface 4. Also, the first external electrode 131 may be disposed on the third surface 3 of the body and may be connected to the first internal electrode 121, and the second external electrode 132 may be disposed on the fourth surface 4 of the body and the be connected to the second internal electrode 122.

That is, the first internal electrode 121 may not be connected to the second external electrode 132 and may be connected to the first external electrode 131, and the second internal electrode 122 may not be connected to the first external electrode 131 and may be connected to the second external electrode 132. Accordingly, the first internal electrode 121 may be spaced apart from the fourth surface 4 at a predetermined distance, and the second internal electrode 122 may be spaced apart from the third surface 3 by a predetermined distance. Also, the first and second internal electrodes 121 and 122 may be spaced apart from the fifth and sixth surfaces of the body 110.

A conductive metal included in the internal electrodes 121 and 122 may be one or more of Ni, Cu, Pd, Ag, Au, Pt, In, Sn, Al, Ti and alloys thereof, but an embodiment thereof is not limited thereto.

The average thickness td of the dielectric layer 111 may not be limited to any particular example, and may be, for example, 0.1 μm to 10 μm. The average thickness te of the internal electrodes 121 and 122 may not be limited to any particular example, and may be, for example, 0.05 μm to 3.0 μm. Also, the average thickness td of the dielectric layer 111 and the average thickness te of the internal electrodes 121 and 122 may be arbitrarily determined according to desired properties or applications. For example, in the case of a high voltage IT electronic component, to implement miniaturization and high capacitance, the average thickness td of the dielectric layer 111 may be 2.8 μm or less, and the average thickness te of the internal electrodes 121 and 122 may be 1 μm or less. Also, in the case of a miniature IT electronic component, to implement miniaturization and high capacitance, the average thickness td of the dielectric layer 111 may be 0.4 μm or less, and the average thickness te of the internal electrodes 121 and 122 may be 0.4 μm or less.

The average thickness td of the dielectric layer 111 and the average thickness te of the internal electrodes 121 and 122 may indicate the sizes of the dielectric layer 111 and the internal electrodes 121 and 122 in the first direction, respectively. The average thickness td of the dielectric layer 111 and the average thickness te of the internal electrodes 121 and 122 may be measured by scanning the cross-sections of the body 110 in the first and second directions using a scanning electron microscope (SEM) at 10,000× magnification. More specifically, the average thickness of the dielectric layer 111 may be measured by measuring the thickness at multiple points of the dielectric layer 111, for example, 30 points at equal distances in the second direction. Also, the average thickness of the internal electrodes 121 and 122 may be measured by measuring the thickness at multiple points of one of the internal electrodes 121 and 122, for example, 30 points at an equal distance in the second direction. The 30 points at equal distance may be designated in the capacitance formation portion. Meanwhile, by measuring the average value on 10 dielectric layers 111 and 10 internal electrodes 121 and 122, and the average thickness of the dielectric layer 111 and the average thickness of the internal electrodes 121 and 122 may be further generalized.

The first external electrode 131 may be disposed on the third surface 3 of the body 110, and the second external electrode 132 may be disposed on the fourth surface 4 of the body 110.

The first external electrode 131 may be connected to the first internal electrode 121, and the second external electrode 132 may be connected to the second internal electrode 122.

The central external electrode 140 may be spaced apart from the first external electrode 131, the second external electrode 132, and the internal electrodes 121 and 122 on one or more of the first and second surfaces 1 and 2 of the body 110. When the length of the multilayer electronic component is defined as L and the length of the central external electrode is defined as CL, CL/L may be 0.10 or more and 0.35 or less. Accordingly, arc discharge may be suppressed and cracks caused by electrostriction may be suppressed.

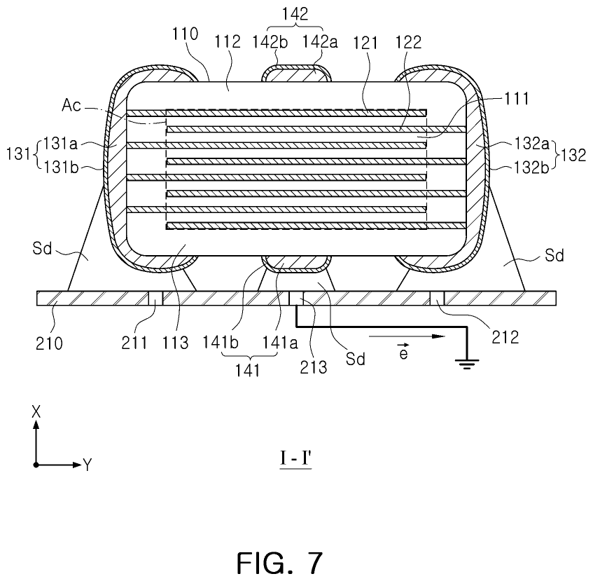

The central external electrode 140 may be disposed on one or more of the first and second surfaces and may be spaced apart from the first and second external electrodes, such that the central external electrode 140 may be disposed between the first and second external electrodes and may absorb current flow due to arc discharge occurring between the first and second external electrodes, thereby suppressing arc discharge. Also, referring to FIG. 7, the multilayer electronic component 100 may be mounted on a substrate 210, and the first external electrode 131, the second external electrode 132, and the central external electrode 140 may be bonded to the first pad 211, the second pad 212, and the third pad 213, respectively, through solder Sd. The central external electrode 140 may be grounded through the third pad 213, and the absorbed current flow (e) may be discharged through the ground.

Also, as the central external electrode 140 is spaced apart from the first external electrode 131, the second external electrode 132, and the internal electrodes 121 and 122, the central external electrode 140 may not affect the capacitor function of the multilayer electronic component.

Also, as the central external electrode 140 is disposed on one or more of the first and second surfaces 1 and 2 of the body 110, the central external electrode 140 may suppress the volume expansion of the body due to electrostriction and cracks caused by electrostriction.

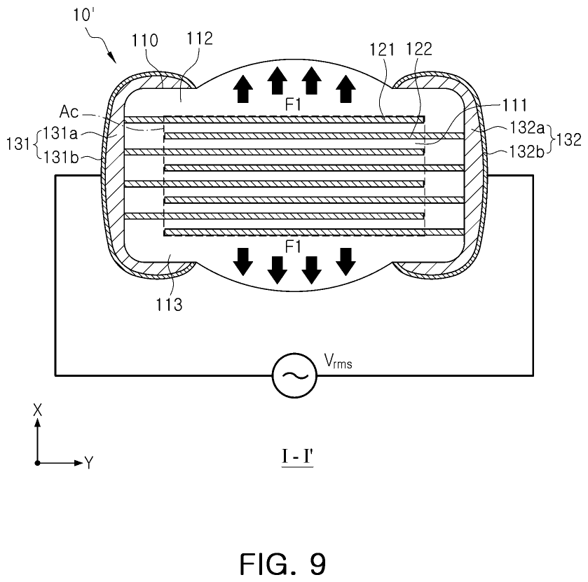

Referring to FIG. 9, when voltage is applied to a general MLCC 10′, an internal electric field may be generated, such that electrostrictive stress F1 due to deformation of the dielectric layer, which causes reduction or expansion, may occur in the direction of laminating the internal electrode and the dielectric layer. Accordingly, the body 110 may expand in the laminate direction, such that storing electrostrictive stress F1 may be applied to the first and second surfaces 1 and 2 of the body, and cracks may be created.

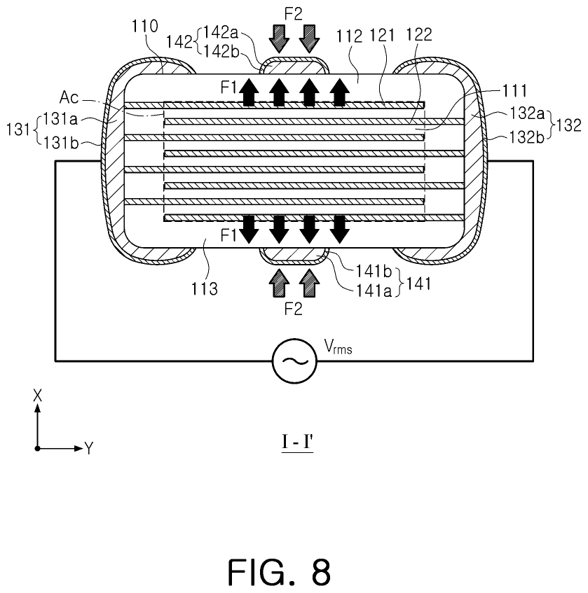

Referring to FIG. 8, in an embodiment, the central external electrode 140 may be disposed on one or more of the first and second surfaces 1 and 2 of the body 110 and may apply stress F2 in the opposite direction of electrostrictive stress F1, thereby suppressing cracks due to electrostriction.

When the length of the multilayer electronic component is defined as L and the length of the central external electrode as CL, CL/L may satisfy 0.10 or more and 0.35 or less, thereby improving the effect of crack suppression and arc discharge suppression caused by electrostriction in the embodiment.

When CL/L is less than 0.10, the current flow caused by arc discharge may not be sufficiently absorbed, or crack suppression due to electrostriction may be insufficient.

When CL/L exceeds 0.35, it may be difficult to sufficiently secure the band portions P1b and P2b of the first and second external electrodes, and moisture resistance reliability may be reduced.

Here, the length L of the multilayer electronic component may indicate the maximum lengthwise size of the multilayer electronic component, measured from the length-thickness cross-section (L-T cross-section) cut at the center in the width direction. The length CL of the central external electrode may indicate the maximum lengthwise size of the central external electrode 140, measured from the length-thickness cross-section (L-T cross-section).

In an embodiment, the first and second external electrodes 131 and 132 may include band portions P1b and P2b extending to portions of the first and second surfaces, respectively.

Referring to FIG. 2, the size in the length direction from an end BE1 of the band portion of the first external electrode to an outermost region OE1 of the first external electrode may be determined as a length BW1 of the band portion of the first external electrode, and the size in the length direction from an end BE2 of the band portion of the second external electrode to an outermost region OE2 of the second external electrode may be determined as a length BW2 of the band portion of the second external electrode. The length BW1 of the band portion of the first external electrode and the length BW2 of the band portion of the second external electrode may be substantially the same, but an embodiment thereof is not limited thereto and there may be an error of approximately 10%.

In an embodiment, when the distance between the end BE1 of the band portion of the first external electrode 131 and the end BE2 of the band portion of the second external electrode 132 is defined as GL, GL/L may be 0.50 or less.

When GL/L exceeds 0.50, arc discharge may not occur, such that, even when the central external electrode 140 is absent, reliability degradation due to arc discharge may not occur.

More preferably, GL/L may be 0.47 or less.

In an embodiment, when the distance between the end BE1 of the band portion of the first external electrode and the end BE2 of the band portion of the second external electrode is defined as GL, GL may be 1500 μm or less.

When the GL exceeds 1500 μm, it is less likely that arc discharge may occur, such that, even without the central external electrode 140, reliability degradation due to arc discharge may not occur.

In an embodiment, when the thickness of the central external electrode 140 is defined as CT, CT may be 10 μm or more. Accordingly, the effect of crack suppression and arc discharge suppression due to electrostriction may be improved in the embodiment. An upper limit of CT may not be specifically limited and may be, for example, 80 μm or less.

In an embodiment, the multilayer electronic component 100 may have a rated voltage of 250 V or higher. That is, the multilayer electronic component 100 may be a high-voltage MLCC. The rated voltage may be measured by methods and/or tools appreciated by one of ordinary skill in the art even if not described in the present disclosure.

In environments with voltages below 250 V, it may be less likely that arc discharge may occur, such that, even without the central external electrode 140, reliability degradation due to arc discharge may not occur.

Also, according to an embodiment, reliability may be ensured even in environments with an applied voltage of 1 kV or higher.

In an embodiment, L may be 3.3 mm or less. When L is 3.3 mm or less, the distance GL between the end BE1 of the band portion of the first external electrode and the end BE2 of the band portion of the second external electrode may decrease, such that it may be highly likely that arc discharge may occur. Thus, the effect of absorbing current flow due to arc discharge according to the central external electrode 140 in the embodiment may be improved.

In an embodiment, the central external electrode 140 may be disposed on both the first and second surfaces. As illustrated in FIGS. 1 to 3, the central external electrode 140 may include a first central external electrode 141 disposed on the first surface and a second central external electrode 142 disposed on the second surface.

By disposing the central external electrodes 141 and 142 on both the first and second surfaces, the effect of suppressing electrostrictive stress F1 may be further enhanced.

The central external electrode 140 may be formed of any material having electrical conductivity, such as metal, and a specific material may be determined in consideration of electrical properties and structural stability, and the central external electrode 140 may have a multilayer structure.

For example, the central external electrode 140 may include central electrode layers 141a and 142a disposed on the body 110 and central plating layers 141b and 142b disposed on the central electrode layer.

For a more specific example of the central electrode layers 141a and 142a, the central electrode layers 141a and 142a may be fired electrodes including a conductive metal and glass, or resin electrodes including a conductive metal and resin.

Also, in the central electrode layers 141a and 142a, a fired electrode and a resin electrode may be formed in order on the body. Also, the central electrode layers 141a and 142a may be formed by transferring a sheet including a conductive metal to the body, or may be formed by transferring a sheet including a conductive metal to the fired electrode.

A material having excellent electrical conductivity may be used as the conductive metal included in the central electrode layers 141a and 142a, and is not limited to any particular example. For example, the conductive metal may be one or more of nickel (Ni), copper (Cu), and alloys thereof.

The central plating layers 141b and 142b may improve mounting properties. The type of the central plating layers 141b and 142b is not limited to any particular example, and may be a plating layer including one or more of Ni, Sn, Pd, and alloys thereof, and may be formed as a plurality of layers.

For a more specific example of the central plating layers 141b and 142b, the central plating layers 141b and 142b may be Ni plating layers or Sn plating layers, and Ni plating layers and Sn plating layers may be formed in order on the central electrode layers 141a and 142a, or Sn plating layers, Ni plating layers, and Sn plating layers may be formed in order. Also, the central plating layers 141b and 142b may include a plurality of Ni plating layers and/or a plurality of Sn plating layers.

In an embodiment, the central external electrode 140 may include central electrode layers 141a and 142a in contact with the body 110 and including a conductive metal and glass. In this case, the central external electrode 140 may further include central plating layers 141b and 142b disposed on the central electrode layers 141a and 142a.

Similarly to the central external electrode 140, the external electrodes 131 and 132 may be formed of any material having electrical conductivity, such as metal, and a specific material may be determined in consideration of electrical properties and structural stability, and the external electrodes 131 and 132 may have a multilayer structure. The external electrodes 131 and 132 may not have the same material and structure as those of the central external electrode 140, and the external electrodes 131 and 132 may have different materials or structures from those of the central external electrode 140.

For example, the external electrodes 131 and 132 may include electrode layers 131a and 132a disposed on the body 110 and plating layers 131b and 132b disposed on the electrode layer. The central external electrode 140 may include central electrode layers 141a and 142a disposed in the body 110 and central plating layers 141b and 142b formed on the central electrode layers 141a and 142a.

For a more specific example of the electrode layers 131a and 132a, the electrode layers 131a and 132a may be fired electrodes including a conductive metal and glass, or resin electrodes including a conductive metal and resin.

Also, in the electrode layers 131a and 132a, a fired electrode and a resin electrode may be formed in order on the body. Also, the electrode layers 131a and 132a may be formed by transferring a sheet including a conductive metal to the body, or may be formed by transferring a sheet including a conductive metal to the fired electrode.

A material having excellent electrical conductivity may be used as the conductive metal included in the electrode layers 131a and 132a, and is not limited to any particular example. For example, the conductive metal may be one or more of nickel (Ni), copper (Cu), and alloys thereof.

The plating layers 131b and 132b may improve mounting properties. The type of the plating layers 131b and 132b is not limited to any particular example, and may be a plating layer including one or more of Ni, Sn, Pd, and alloys thereof, and may be formed as a plurality of layers.

For a more specific example of the plating layers 131b and 132b, the plating layers 131b and 132b may be Ni plating layers or Sn plating layers, and Ni plating layers and Sn plating layers may be formed in order on the electrode layers 131a and 132a, or Sn plating layers, Ni plating layers, and Sn plating layers may be formed in order. Also, the plating layers 131b and 132b may include a plurality of Ni plating layers and/or a plurality of Sn plating layers.

The size of the multilayer electronic component 100 may not be limited to any particular example. For example, the size of the multilayer electronic component 100 may be 0201 (length×width, 0.2 mm×0.1 mm), 0603 (length×width, 0.6 mm×0.3 mm), 1005 (length×width, 1.0 mm×0.5 mm), 2012 (length×width, 2.0 mm×1.2 mm), 3216 (length×width, 3.2 mm×1.6 mm), 3225 (length×width, 3.2 mm×2.5 mm), or the like.

The shape of the central external electrode 141, 142 may not be limited to the shape illustrated in FIGS. 1 to 3.

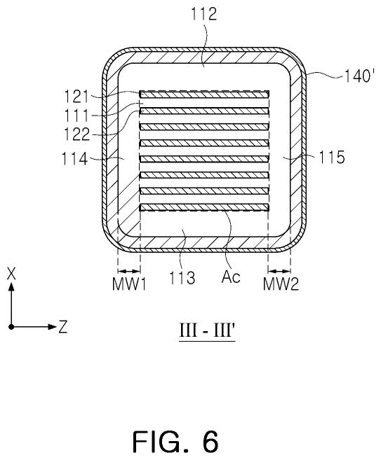

FIG. 5 is a perspective diagram illustrating a multilayer electronic component according to a modified example. FIG. 6 is a cross-sectional diagram taken along line III-III′ in FIG. 5. Referring to FIGS. 5 and 6, a central external electrode 140′ of a multilayer electronic component 100′ according to a modified example may be disposed to surround the first, second, fifth, and sixth surfaces of the body. Accordingly, as the central external electrode 140′ may firmly fix the body, the effect of suppressing electrostrictive stress F1 may be improved.

### EXPERIMENTAL EXAMPLE

Sample chips satisfying Table 1 below were manufactured, and moisture resistance reliability was evaluated. The band portions having lengths of BW1 and BW2, respectively, were manufactured in the same manner, and in Table 1, “BW” indicates BW1 or BW2.

As for moisture resistance reliability, the sample chip was mounted on the substrate, a voltage of 1 kV was applied at a temperature of 85° C. and a relative humidity of 85%, and when the insulation resistance value decreased to 1/100 or less as compared to the initial value, the elapsed time (hr) after the voltage was applied was listed. When the insulation resistance value remained higher than 1/100 as compared to the initial value for 1000 hours after applying a voltage of 1 kV, the sample was marked as PASS.

TABLE 1

| | | | | | | | | Moisture |
|---|---|---|---|---|---|---|---|---|
| Classifi- | L | BW | GL | | CL | | CT | resistance |
| cation | (μm) | (μm) | (μm) | GL/L | (μm) | CL/L | (μm) | reliability |
| Compar- | 3200 | 850 | 1500 | 0.47 | 0 | 0.00 | 0 | 760 hr |
| ative | | | | | | | | |
| example 1 | | | | | | | | |
| Compar- | 3200 | 950 | 1300 | 0.41 | 0 | 0.00 | 0 | 520 hr |
| ative | | | | | | | | |
| example 2 | | | | | | | | |
| Example 1 | 3200 | 350 | 2500 | 0.78 | 640 | 0.20 | 60 | PASS |
| Example 2 | 3200 | 450 | 2300 | 0.72 | 640 | 0.20 | 60 | PASS |
| Example 3 | 3200 | 550 | 2100 | 0.66 | 640 | 0.20 | 60 | PASS |
| Example 4 | 3200 | 650 | 1900 | 0.59 | 640 | 0.20 | 60 | PASS |
| Example 5 | 3200 | 750 | 1700 | 0.53 | 640 | 0.20 | 60 | PASS |
| Example 6 | 3200 | 850 | 1500 | 0.47 | 640 | 0.20 | 60 | PASS |
| Example 7 | 3200 | 950 | 1300 | 0.41 | 640 | 0.20 | 60 | PASS |
| Example 8 | 3200 | 850 | 1500 | 0.47 | 320 | 0.10 | 60 | PASS |
| Example 9 | 3200 | 850 | 1500 | 0.47 | 1100 | 0.34 | 60 | PASS |
| Compar- | 3200 | 850 | 1500 | 0.47 | 250 | 0.08 | 60 | 850 hr |
| ative | | | | | | | | |
| example 3 | | | | | | | | |
| Compar- | 3200 | 950 | 1300 | 0.41 | 1200 | 0.38 | 60 | 910 hr |
| ative | | | | | | | | |
| example 4 | | | | | | | | |
| Compar- | 2000 | 530 | 940 | 0.47 | 140 | 0.07 | 40 | 880 hr |
| ative | | | | | | | | |
| example 5 | | | | | | | | |
| Compar- | 2000 | 630 | 740 | 0.37 | 720 | 0.36 | 40 | 780 hr |
| ative | | | | | | | | |
| example 6 | | | | | | | | |
| Example | 2000 | 530 | 940 | 0.47 | 240 | 0.12 | 40 | PASS |
| 10 | | | | | | | | |
| Example | 2000 | 630 | 740 | 0.37 | 660 | 0.33 | 40 | PASS |
| 11 | | | | | | | | |

Referring to Table 1, as for comparative examples 1 and 2, in which a central external electrode was not present, moisture resistance reliability was degraded, which may be interpreted that electrostriction cracks occurred due to prolonged use under high voltage (1 kV), or radial cracks occurred such that insulation resistance was lowered.

Examples 1 to 11 had excellent moisture resistance reliability, as CL/L satisfied 0.10 or more and or 0.35 or less.

In comparative examples 3 to 6, the central external electrode was disposed, but CL/L did not satisfy 0.10 or more and or 0.35 or less, such that moisture resistance reliability was deteriorated.

According to the aforementioned embodiments, a multilayer electronic component having improved reliability may be provided.

Also, arc discharge may be suppressed even in high-voltage environment.

Also, cracks caused by electrostriction may be suppressed.

The embodiments do not necessarily limit the scope of the embodiments to a specific embodiment form. Instead, modifications, equivalents and replacements included in the disclosed concept and technical scope of this description may be employed. Throughout the specification, similar reference numerals are used for similar elements.

In the embodiments, the term “embodiment” may not refer to one same embodiment, and may be provided to describe and emphasize different unique features of each embodiment. The above suggested embodiments may be implemented do not exclude the possibilities of combination with features of other embodiments. For example, even though the features described in an embodiment are not described in the other embodiment, the description may be understood as relevant to the other embodiment unless otherwise indicated.

An expression used in the singular encompasses the expression of the plural, unless it has a clearly different meaning in the context.

While the embodiments have been illustrated and described above, it will be configured as apparent to those skilled in the art that modifications and variations could be made without departing from the scope of the present disclosure as defined by the appended claims.

What is claimed is:

1. A multilayer electronic component, comprising:
a dielectric layer and internal electrodes alternately disposed with the dielectric layer in a thickness direction;
a body including first and second surfaces opposing each other in the thickness direction, third and fourth surfaces connected to the first and second surfaces and opposing each other in a length direction, and fifth and sixth surfaces connected to the first to fourth surfaces and opposing each other in a width direction;
a first external electrode disposed on the third surface;
a second external electrode disposed on the fourth surface; and
a central external electrode spaced apart from the first external electrode, the second external electrode, and the internal electrodes,
wherein the central external electrode is disposed on one or more of the first and second surfaces of the body,
wherein, when a length of the multilayer electronic component is defined as L and a length of the central external electrode is defined as CL, CL/L is 0.10 or more and 0.35 or less.

2. The multilayer electronic component of claim 1, wherein each of the first and second external electrodes includes a band portion extending to a portion of the first and second surfaces.

3. The multilayer electronic component of claim 2, wherein, when a distance between an end of the band portion of the first external electrode and an end of the band portion of the second external electrode is defined as GL, GL/L is 0.50 or less.

4. The multilayer electronic component of claim 3, wherein GL/L is 0.47 or less.

5. The multilayer electronic component of claim 2, wherein, when a distance between an end of the band portion of the first external electrode and an end of the band portion of the second external electrode is defined as GL, GL is 1500 μm or less.

6. The multilayer electronic component of claim 1, wherein, when a thickness of the central external electrode is defined as CT, CT is 10 μm or more.

7. The multilayer electronic component of claim 1, wherein the multilayer electronic component has a rated voltage of 250V or higher.

8. The multilayer electronic component of claim 1, wherein L is 3.3 mm or less.

9. The multilayer electronic component of claim 1, wherein the central external electrode is disposed on both the first and second surfaces.

10. The multilayer electronic component of claim 1, wherein the central external electrode is disposed to surround the first, second, fifth and sixth surfaces.

11. The multilayer electronic component of claim 1, wherein the central external electrode includes a central electrode layer in contact with the body and including conductive metal and glass.

12. The multilayer electronic component of claim 11, wherein the central external electrode further includes a central plating layer disposed on the central electrode layer.

13. The multilayer electronic component of claim 1, wherein, when a thickness of the central external electrode is defined as CT, CT is 10 μm or more and 80 μm or less.

14. The multilayer electronic component of claim 1, wherein, when a thickness of the first external electrode or the second external electrode is defined as BT, BT is 10 μm or more and 75 μm or less.

15. The multilayer electronic component of claim 1, wherein the central external electrode is disposed to completely surround the first, second, fifth and sixth surfaces.

16. The multilayer electronic component of claim 1, wherein the central external electrode is disposed on a portion of the fifth surface and a portion of the sixth surface.
